(19) United States
(12) Patent Application Publication
(10) Pub. No.: US 2024/0161450 A1
(43) Pub. Date: May 16, 2024

(54) FEATURE EXTRACTION APPARATUS, INFORMATION PROCESSING APPARATUS, METHOD, AND NON-TRANSITORY COMPUTER READABLE MEDIUM STORING PROGRAM

(71) Applicant: NEC Corporation, Tokyo (JP)

(72) Inventor: Satoshi Yamazaki, Tokyo (JP)

(73) Assignee: NEC Corporation, Tokyo (JP)

(21) Appl. No.: 18/384,957

(22) Filed: Oct. 30, 2023

(30) Foreign Application Priority Data
Nov. 14, 2022 (JP) 2022-181886

(51) Int. Cl. G06V 10/46; G06V 10/22

(52) U.S. Cl. CPC G06V 10/46; G06V 10/22

(57) ABSTRACT

A feature extraction apparatus, a method, and a program capable of efficiently using processing resources are provided. In a feature extraction apparatus, a feature extraction unit receives an object image and extracts features of an object included in the received object image. The determination unit determines a value of M (the value of M is an integer equal to or larger than one but equal to or smaller than N), which is the number of object images whose features will be extracted of N object images with which the first tracking ID is associated, in accordance with a usage status of processing resources of the feature extraction apparatus.

### INCORPORATION BY REFERENCE

This application is based upon and claims the benefit of priority from Japanese patent application No. 2022-181886, filed on Nov. 14, 2022, the disclosure of which is incorporated herein in its entirety by reference.

### TECHNICAL FIELD

The present disclosure relates to a feature extraction apparatus, an information processing apparatus, a method, and a program.

### BACKGROUND ART

A technique for detecting an image of a region that corresponds to a target object (object) (i.e., an object image) in a captured image and tracking the target object has been proposed (e.g., International Patent Publication No. WO2020/217368). In International Patent Publication No. WO2020/217368, an information processing apparatus tracks a plurality of target objects included in a captured image. Then, the information processing apparatus predicts qualities of features of each target object, and then extracts only those features of target objects which have predicted qualities of features that satisfy a predetermined condition.

### SUMMARY

The present inventors have found that it is possible that processing resources of an information processing apparatus (a feature extraction apparatus) may not be efficiently used in the technique disclosed in International Patent Publication No. WO2020/217368 since a usage status of the processing resources of the information processing apparatus is not taken into account. That is, in the technique disclosed in International Patent Publication No. WO2020/217368, even in a situation where there is a sufficient margin for processing resources of the information processing apparatus, features will be extracted uniformly only for a target object that satisfies a predetermined condition. Therefore, it is possible that the processing resources of the information processing apparatus may not be efficiently used.

An object of the present disclosure is to provide a feature extraction apparatus, a method, and a program capable of efficiently using processing resources. It should be noted that this object is merely one of a plurality of objects that a plurality of example embodiments disclosed herein will attain. The other objects or problems and novel features will be made clear from the descriptions in the specification or accompanying drawings.

In one aspect, a feature extraction apparatus includes: a feature extraction unit configured to receive an object image and extract at least one feature of an object included in the received object image; and a determination unit configured to determine a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

In another aspect, an information processing apparatus includes: the feature extraction apparatus according to the above aspect; a detection unit configured to detect, in each of a plurality of captured images, an object region that corresponds to an object, identify positions of the respective object regions in the captured images, attach object IDs to the respective object regions, and output a plurality of object images, each of the object images including a captured image where the object region is detected, image identification information indicating the captured image, information regarding the identified position, and the object ID; and a tracking unit configured to attach one tracking ID to all object images of one object using the plurality of object images received from the detection unit and output, to the feature extraction apparatus, the plurality of object images to which the tracking ID is attached.

In another aspect, a method executed by a feature extraction apparatus includes: extracting at least one feature of an object included in an object image; and determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

In another aspect, a program causes a feature extraction apparatus to execute processing including: extracting at least one feature of an object included in an object image; and determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing one example of a feature extraction apparatus according to a first example embodiment;

FIG. 2 is a flowchart showing one example of a process operation of the feature extraction apparatus according to the first example embodiment;

FIG. 3 is a block diagram showing one example of an information processing apparatus according to a second example embodiment;

FIG. 4 is a diagram showing one example of object information output from an information output unit;

FIG. 5 is a flowchart showing one example of a process operation of a selection unit of a feature extraction apparatus according to a second example embodiment;

FIG. 6 is a flowchart showing one example of a process operation of a determination unit and a sorting unit of the feature extraction apparatus according to the second example embodiment;

FIG. 7 is a block diagram showing one example of an information processing apparatus according to a third example embodiment; and

FIG. 8 is a diagram showing a hardware configuration example of the feature extraction apparatus.

### EXAMPLE EMBODIMENT

Hereinafter, with reference to the drawings, example embodiments will be described. In the example embodiments, the same or equivalent components are denoted by the same reference symbols and redundant descriptions will be omitted.

### First Example Embodiment

### <Configuration Example of Feature Extraction Apparatus>

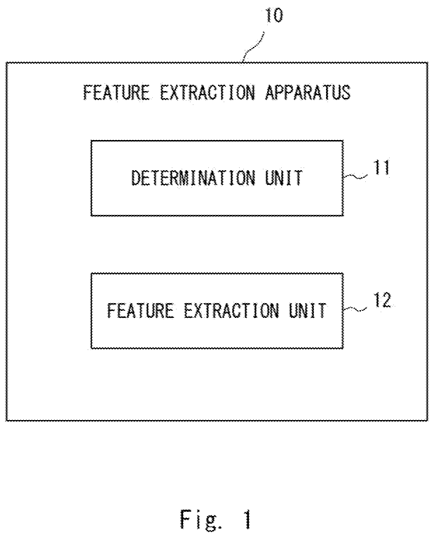

FIG. 1 is a block diagram showing one example of a feature extraction apparatus according to a first example embodiment. In FIG. 1, a feature extraction apparatus 10 includes a determination unit 11 and a feature extraction unit 12.

The feature extraction unit 12 receives object images and extracts features of objects included in the received object images. As described above, the “object image” may be, for example, an image of a region that corresponds to a target object (object) in a captured image. The “object” may be, for example, an animal (including a human being) or a mobile body other than living creatures (e.g., a vehicle or a flying object). Hereinafter, as an example, the description will be given based on the assumption that the “object” is a person.

Further, “features to be extracted” may be, for example, any feature that can be used to identify the object. For example, the features to be extracted may be visual features representing the color, shape, pattern, and/or the like of the object. The features to be extracted may be a histogram of a color or a luminance gradient feature, local features such as Scale Invariant Feature Transform (SIFT) or Speeded Up Robust Features (SURF), or features describing a pattern such as Gabor wavelet. The features to be extracted may be features for object identification or features (appearance features) used for re-identification of an object obtained by deep learning. The features to be extracted may be attribute features such as the age. The features to be extracted may be skeletal features of joint positions.

The determination unit 11 determines a value of M (the value of M is an integer equal to or larger than one but equal to or smaller than N), which is the number of object images whose features will be extracted of N (the value of N is an integer equal to or larger than two) object images with which one tracking identifier (tracking ID) (hereinafter it will be referred to as a “first tracking ID”) is associated. Accordingly, of the N object images with which the first tracking ID is associated, features of M object images are extracted in the feature extraction unit 12, whereas features of (N−M) object images are not extracted as the (N−M) object images are not regarded to be targets whose features will be extracted. In this example, the value of M is an integer equal to or larger than one but equal to or smaller than N and the minimum value of the value of M is set to 1. However, the minimum value of the value of M is not limited to 1 and may be any integer equal to or larger than 0 but equal to or smaller than N.

In particular, the determination unit 11 determines the value of M in accordance with “a usage status of processing resources of the feature extraction apparatus 10”. The “usage status of the processing resources” of the feature extraction apparatus 10 is not limited thereto and may be, for example, a “machine resource usage rate” of the feature extraction apparatus 10. A specific example of the “usage status of the processing resources” will be described later.

### <Operation Example of Feature Extraction Apparatus>

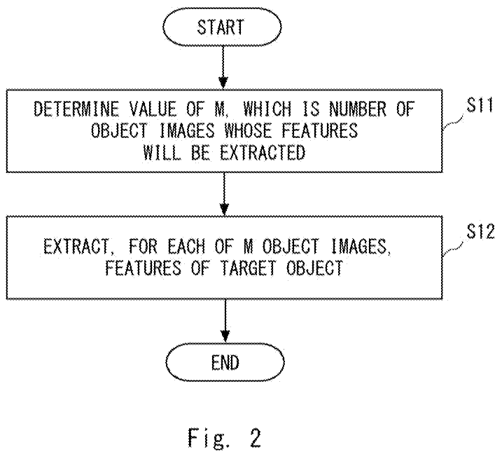

FIG. 2 is a flowchart showing one example of a process operation of a feature extraction apparatus according to the first example embodiment.

The determination unit 11 determines the value of M (the value of M is an integer equal to or larger than one but equal to or smaller than N), which is the number of object images whose features will be extracted of the N object images with which the first tracking ID is associated, in accordance with the usage status of the processing resources of the feature extraction apparatus 10 (Step S11). Accordingly, the M object images will be input to the feature extraction unit 12 as targets whose features will be extracted.

The feature extraction unit 12 receives the above M object images and extracts, for each of these M object images, features of the target object (Step S12).

As described above, according to the first example embodiment, in the feature extraction apparatus 10, the determination unit 11 determines the value of M (the value of M is an integer equal to or larger than one but equal to or smaller than N), which is the number of object images whose features will be extracted of the N object images with which the first tracking ID is associated, in accordance with the usage status of the processing resources of the feature extraction apparatus 10.

With the configuration of the above feature extraction apparatus 10, when there are enough processing resources of the feature extraction apparatus 10, the value of M can be made large, whereby it is possible to efficiently use processing resources of the feature extraction apparatus 10.

### Second Example Embodiment

A second example embodiment relates to a more specific example embodiment.

### <Configuration Example of Information Processing Apparatus>

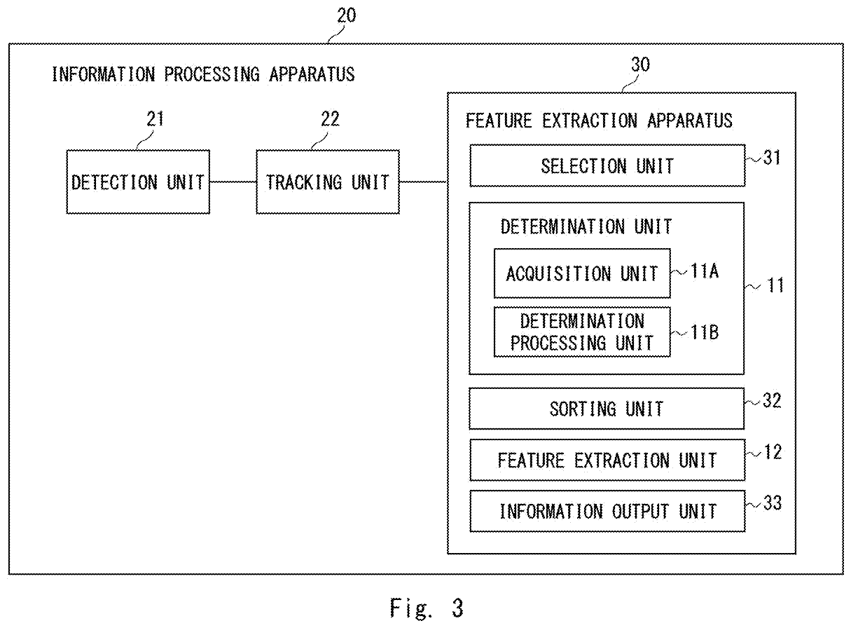

FIG. 3 is a block diagram showing one example of an information processing apparatus according to the second example embodiment. In FIG. 3, an information processing apparatus 20 includes a detection unit 21, a tracking unit 22, and a feature extraction apparatus 30.

The detection unit 21 detects, for each of a plurality of captured images, a region that corresponds to a target object (object) (i.e., an “object region”) and obtains an index indicating a probability that the type of the object included in the detected region is a type of a target object (i.e., “object type reliability”). Information with which an image is to be identified (i.e., “image identification information”) is attached to each of the plurality of captured images. For example, the plurality of captured images is a plurality of image frames that form a video image. For example, as image identification information, a time or a frame number of an image frame is attached to each of the image frames.

Then, the detection unit 21 identifies the positions of the respective object regions in the captured images. For example, the detection unit 21 may identify the position of a rectangular region that surrounds an object region (e.g., the region inside the contour of the object region) as a “position of the object region in the captured image”. The position of the rectangular region may be expressed, for example, by coordinates of the vertices of the rectangular region (e.g., coordinates of the top left vertex and coordinates of the lower right vertex). Alternatively, the position of this rectangular region may be expressed, for example, by coordinates of one vertex (e.g., coordinates of the top left vertex), and the width and the height of the rectangular region. That is, the detection unit 21 obtains “position information” of each object region.

Then, the detection unit 21 attaches “object IDs” to the respective object regions. The detection unit 21 attaches object IDs to all the object regions, the object IDs being different from one another.

Here, it is possible to identify the detected object region from the “image identification information”, the “object ID”, and the “position information”. In the following, the “image identification information”, the “object ID”, the “position information”, and the “object type reliability” may be collectively referred to as an “object region (or object region information)”.

Then, the detection unit 21 outputs a plurality of captured images and “object region information” regarding each of the object regions that have been detected to the tracking unit 22. Note that the “object image” can be identified by the “object region information” and the captured image where the object region that corresponds to this “object region information” has been detected. In the following, the “object region information” and the captured image where the object region that corresponds to this “object region information” has been detected may collectively referred to as an “object image (or object image information)”.

When the target object is a person, the detection unit 21 may detect an object region (i.e., a person region) using a detector that has learned image features of the person. The detection unit 21 may use, for example, a detector that detects the object region based on Histograms of Oriented Gradients (HOG) features or a detector that directly detects the object region from an image using a Convolutional Neural Network (CNN). Alternatively, the detection unit 21 may detect a person using a detector that has learned a partial region of a person (e.g., a head part or the like), not the entire person. The detection unit 21 may identify, for example, a person region by detecting a head position or a foot position using a detector that has learned the head or the foot. The detection unit 21 may obtain the person region by combining, for example, silhouette information obtained from a background difference (information on an area where there are differences from a background model) and head part detection information.

The tracking unit 22 executes “tracking processing” using the plurality of captured images and the “object region information” regarding each object region that has been detected, the captured images and the “object region information” being received from the detection unit 21. The tracking unit 22 executes “tracking processing”, thereby attaching one “tracking ID” to all the object region information items regarding one target object (e.g., a person A).

For example, the tracking unit 22 predicts a region where there is an object region that corresponds to a tracking ID #1 (predicted region) in a first image frame by applying a Kalman filter or a particle filter to the object region which has been detected in one or more image frames which is temporally before the first image frame and to which the tracking ID #1 has been attached. Then, the tracking unit 22 attaches, for example, the tracking ID #1 to object regions that overlap the predicted region of a plurality of object regions in the first image frame. Alternatively, the tracking unit 22 may perform tracking processing using a Kanade-Lucas-Tomasi (KLT) algorithm.

The tracking unit 22 then outputs a plurality of object images to which the tracking IDs have been attached to the feature extraction apparatus 30.

As shown in FIG. 3, for example, the feature extraction apparatus 30 includes a determination unit 11, a feature extraction unit 12, a selection unit 31, a sorting unit 32, and an information output unit 33.

The selection unit 31 receives, from the tracking unit 22, the plurality of object images to which tracking IDs have been attached. In the following, when a certain one tracking ID is focused on, this tracking ID may be referred to as an “attention tracking ID”. Then, the selection unit 31 selects, from the plurality of object images with which the attention tracking ID is associated, some or all of the plurality of object images based on object identification reliabilities of the plurality of object images. In other words, the selection unit 31 selects, from P (the value of P is an integer equal to or larger than N) object images with which the attention tracking ID is associated, N object images based on P object type reliabilities associated with the respective P object images. For example, the selection unit 31 may select, from the P object images, N object images from the one having the highest object type reliability.

While the description has been given assuming that the selection unit 31 selects object images based on the object identification reliabilities, the present disclosure is not limited thereto. For example, the selection unit 31 may select object images based on reliabilities other than the object identification reliabilities. The reliabilities other than the object identification reliabilities may be, for example, “the number of human body joint points that can be visually recognized” in order to select human body features that are suitable for re-identification of a person. In this case, the detection unit 21 outputs, in place of the above “object identification reliabilities”, other reliabilities (the number of human body joint points that can be visually recognized) to the tracking unit 22. Then, the selection unit 31 may select, from the P object images, N object images from the one having the largest number of human body joint points that can be visually recognized.

Further, the selection unit 31 may calculate “priority scores” from the object identification reliabilities, other reliabilities, or the like instead of directly using the object identification reliabilities and other reliabilities as criteria. Then, the selection unit 31 may select, from the P object images, N object images from the one having the highest priority score.

The above “object identification reliabilities”, the “other reliabilities”, and the “priority scores” may be collectively referred to as a “priority”.

The above selection processing may be performed as the number of object images which are accumulated in the selection unit 31 and with which the attention tracking ID is associated has become equal to or larger than a predetermined threshold. Then, the selection unit 31 outputs the N selected object images to the determination unit 11 and the sorting unit 32, and outputs (P−N) object images other than the N selected object images to the information output unit 33.

As described in the first example embodiment, the determination unit 11 determines the value of M (the value of M is an integer equal to or larger than one but equal to or smaller than N), which is the number of object images whose features will be extracted of the N (the value of N is an integer equal to or larger than two) object images with which the attention tracking ID is associated. In particular, the determination unit 11 determines the value of M in accordance with “the usage status of the processing resources of the feature extraction apparatus 10”.

For example, as shown in FIG. 3, the determination unit 11 includes an acquisition unit 11A and a determination processing unit 11B.

The acquisition unit 11A acquires “the usage status of the processing resources of the feature extraction apparatus 10”. For example, the acquisition unit 11A may acquire the number of times of feature extraction processing that has been actually executed in the most recent “unit period” as “the usage status of the processing resources of the feature extraction apparatus 10”. The “unit period” may be, for example, a period with a time length of five seconds.

The determination processing unit 11B calculates (determines), for example, “the number of times of feature extraction processing that is allowed” by subtracting “the number of times of feature extraction processing that has been actually executed in the most recent unit period” acquired in the acquisition unit 11A from “the maximum number of times of feature extraction processing in the unit period”. The “number of times of feature extraction processing that is allowed” corresponds to the maximum value of the number of object images that are allowed as targets whose features will be extracted. Assume, for example, that the unit period is a period with a time length of five seconds. At this time, the determination processing unit 11B may calculate (determine) “the number of times of feature extraction processing that is allowed” by subtracting, for example, “the number of times of feature extraction processing that has been actually executed during the most recent five seconds” acquired in the acquisition unit 11A from “the maximum number of feature extraction processing in a unit period with a time length of five seconds”.

Then, when the value of N is equal to or smaller than “the number of times of feature extraction processing that is allowed”, the determination processing unit 11B may determine the value of M, assuming that N=M. Further, when the above value of N is larger than “the number of times of feature extraction processing that is allowed”, the determination processing unit 11B may determine the value of M, assuming that “the number of times of feature extraction processing that is allowed”=M. Note that “the maximum number of times of feature extraction processing in the unit period” may be set in the determination unit 11 in advance by the user of the feature extraction apparatus 30.

The sorting unit 32 selects the M object images from the above N object images received from the selection unit 31. The value of M is the value determined in the determination processing unit 11B. Then, the sorting unit 32 outputs the M object images whose “features will be extracted” to the feature extraction unit 12, and outputs, of the N object images, (N-M) object images whose “features will not be extracted” other than the M object images whose features will be extracted to the information output unit 33.

The feature extraction unit 12 receives the object images and extracts features of objects included in the received object images. Then, the feature extraction unit 12 outputs the object images in association with the features extracted from the object images to the information output unit 33.

The information output unit 33 outputs “object information” including the information received from the selection unit 31, the sorting unit 32, and the feature extraction unit 12. That is, the “object information” at least includes, for example, the object image ID of each of the M object images whose features will be extracted and “extracted information” indicating that the features of each of the M object images whose features will be extracted have been extracted, and the object image ID of each of the (N−M) object images whose features will not be extracted and “unextracted information” indicating that the features of each of the (N−M) object images whose features will not be extracted have not been extracted.

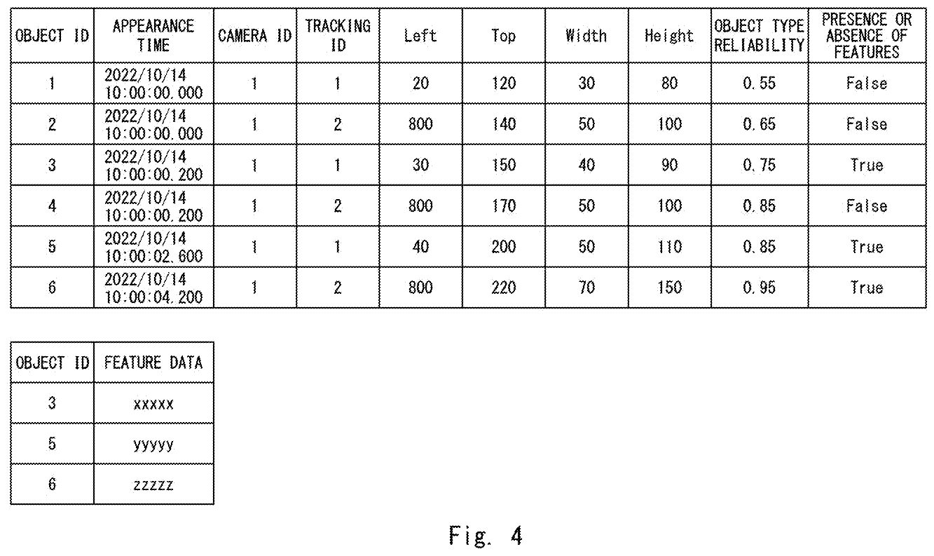

FIG. 4 is a diagram showing one example of object information output from the information output unit. FIG. 4 shows the object information in a form of a table. Each entry of the table shown in FIG. 4 corresponds to the above one “object image”. Each entry includes, as items, an “object ID”, an “appearance time”, a “camera ID”, a “tracking ID”, “Left”, “Top”, “Width”, “Height”, “object type reliability”, and “presence or absence of features”. Further, the object information includes, regarding an object image whose features have been extracted, the object ID that corresponds to this object image in association with data regarding features. The data regarding features may have, for example, a format of a binary string. Here, the time or the frame number of the image frame may be used as the value of the item “appearance time”. Further, the camera ID is an ID for identifying a camera used to capture a captured image to be processed by the detection unit 21 and the tracking unit 22. Further, the values of the items “Left” and “Top” correspond to the coordinates of the top left vertex of the above rectangular region. Further, the items “Width” and “Height” correspond to the width and the height of the above rectangular region. Further, the value of the item “presence or absence of features” is indicated by “False” or “True”. “False” corresponds to the above “unextracted information” and “True” corresponds to the above “extracted information”. Note that all the values of “presence or absence of features” of the object images output from the selection unit 31 to the information output unit 33 are “False”.

### <Operation Example of Information Processing Apparatus>

One example of a process operation of the information processing apparatus 20 having the aforementioned configuration will be described. In this example, in particular, one example of the process operation of the selection unit 31, the determination unit 11, and the sorting unit 32 of the feature extraction apparatus 30 will be described.

### (Process Operation Example of Selection Unit)

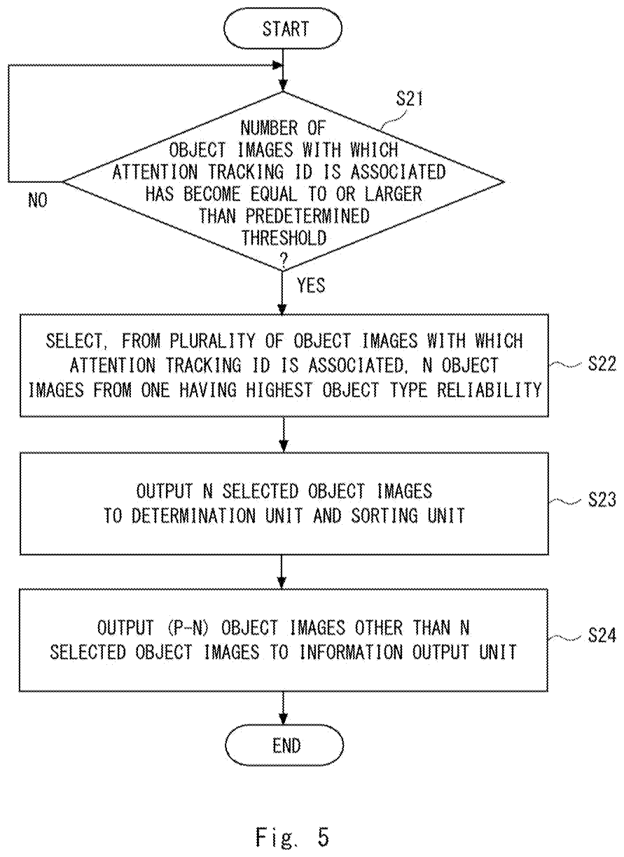

FIG. 5 is a flowchart showing one example of a process operation of the selection unit of the feature extraction apparatus according to the second example embodiment. The process flow in FIG. 5 is executed, assuming that each tracking ID is an attention tracking ID.

The selection unit 31 receives, from the tracking unit 22, a plurality of “object images” to which tracking IDs are attached, and temporarily holds the received object images. As described above, each “object image” includes “object region information” and a captured image where the corresponding object region has been detected. Further, the “object region information” includes “image identification information”, an “object ID”, “position information”, and “object type reliability”.

The selection unit 31 waits until the number of object images which are accumulated in the selection unit 31 and with which the attention tracking ID is associated becomes equal to or larger than a predetermined threshold (NO in Step S21). The value of the predetermined threshold is a value equal to or larger than N. When the number of object images which are accumulated in the selection unit 31 and with which the attention tracking ID is associated becomes equal to or larger than the predetermined threshold (YES in Step S21), the selection unit 31 selects, from the P (the value of P is an integer equal to or larger than N) object images with which the attention tracking ID is associated, N object images from the one having the highest object type reliability (Step S22).

The selection unit 31 outputs the N selected object images to the determination unit 11 and the sorting unit 32 (Step S23). The selection unit 31 outputs (P−N) object images other than the N selected object images to the information output unit 33 (Step S24). The process flow in FIG. 5 is executed repeatedly.

### (Process Operation Example of Determination Unit and Sorting Unit)

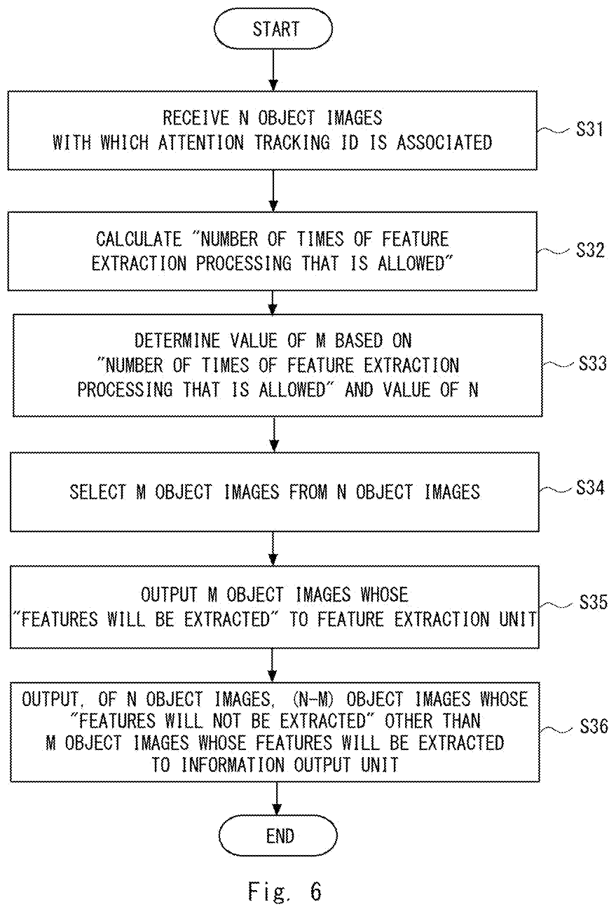

FIG. 6 is a flowchart showing one example of a process operation of the determination unit and the sorting unit of the feature extraction apparatus according to the second example embodiment. The process flow in FIG. 6 is executed, assuming that each tracking ID is an attention tracking ID.

Each of the determination unit 11 and the sorting unit 32 receives N (the value of N is an integer equal to or larger than two) object images with which the attention tracking ID is associated (Step S31).

The determination unit 11 calculates “the number of times of feature extraction processing that is allowed” (Step S32). For example, as described above, the determination unit 11 subtracts, from “the maximum number of the feature extraction processing in the unit period”, “the number of times of feature extraction processing that has been actually executed in the most recent unit period” acquired in the acquisition unit 11A, thereby calculating “the number of times of feature extraction processing that is allowed”.

The determination unit 11 determines the value of M based on the calculated “number of times of feature extraction processing that is allowed” and the above value of N (Step S33).

The sorting unit 32 selects M object images from the N object images received from the selection unit 31 (Step S34).

The sorting unit 32 outputs M object images whose “features will be extracted” to the feature extraction unit 12 (Step S35).

The sorting unit 32 outputs, of the N object images, (N−M) object images whose “features will not be extracted” other than the M object images whose features will be extracted to the information output unit 33 (Step S36).

As described above, according to the second example embodiment, the selection unit 31 of the feature extraction apparatus 30 selects, from P (the value of P is an integer equal to or larger than N) object images with which an attention tracking ID is associated, N object images based on P object type reliabilities associated with the respective P object images. Then the selection unit 31 outputs the N selected object images to the determination unit 11 and the sorting unit 32.

According to the configuration of the feature extraction apparatus 30, it is possible to first exclude object images with a low object type reliability from which it is unlikely that effective features will be obtained, from the target from which features will be extracted.

### Modified Example

Note that the acquisition unit 11A may acquire “the number of threads that are currently used in a thread pool used in feature extraction processing” as “the usage status of the processing resources of the feature extraction apparatus 10”. In this case, the determination processing unit 11B may calculate “the number of threads that are currently available in a thread pool used in feature extraction processing” by subtracting, for example, “the number of threads that are currently used in the thread pool used in feature extraction processing” from “the number of threads in the thread pool used in feature extraction processing”. The “number of threads that are currently available in the thread pool used in feature extraction processing” corresponds to “the number of times of feature extraction processing that is allowed” stated above. The thread pool means a mechanism in which requests (processing) put into a queue are sequentially executed by threads prepared by the thread pool.

### Third Example Embodiment

A third example embodiment relates to an example embodiment in which images captured by a plurality of respective cameras are processed by one information processing apparatus.

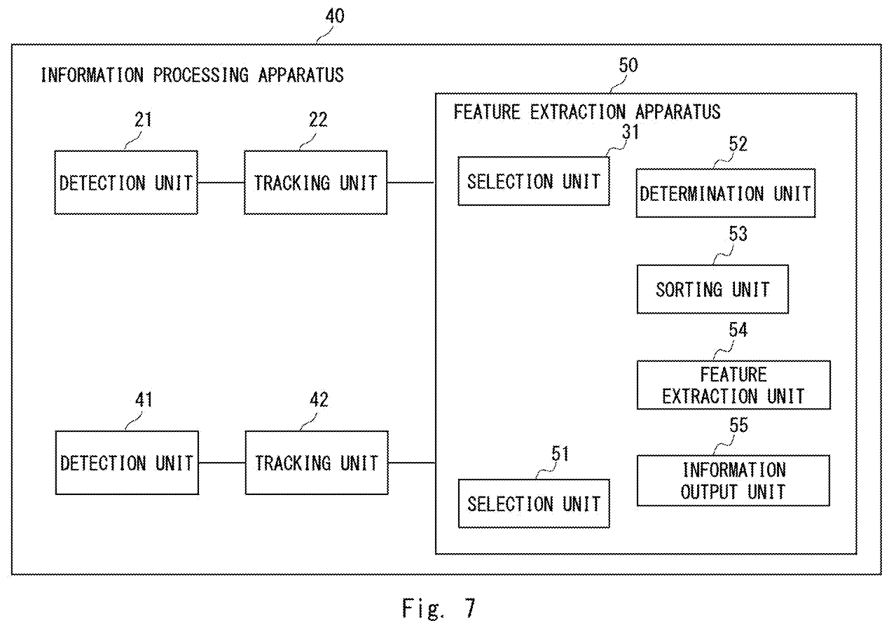

FIG. 7 is a block diagram showing one example of the information processing apparatus according to the third example embodiment. In FIG. 7, an information processing apparatus 40 includes a detection unit 21, a tracking unit 22, a detection unit 41, a tracking unit 42, and a feature extraction apparatus 50.

The detection unit 41 and the tracking unit 42 have functions the same as those of the above detection unit 21 and the above tracking unit 22. However, the detection unit 21 and the tracking unit 22 perform processing on images captured by a first camera, whereas the detection unit 41 and the tracking unit 42 perform processing on images captured by a second camera different from the first camera. While the description is given assuming that the information processing apparatus 40 includes two sets, each set including a detection unit and a tracking unit, for the sake of simplification of the description in this example, the present disclosure is not limited thereto. That is, the information processing apparatus 40 may include three or more sets, each set including a detection unit and a tracking unit. In this case, three or more sets, each set including a detection unit and a tracking unit, perform processing on images captured by cameras different from each other.

As shown in FIG. 3, for example, the feature extraction apparatus 30 includes a selection unit 31, a selection unit 51, a determination unit 52, a sorting unit 53, a feature extraction unit 54, and an information output unit 55.

The selection unit 51 includes a function the same as that of the selection unit 31. The selection unit 51 receives, from the tracking unit 42, a plurality of object images to which tracking IDs have been attached. The plurality of object images are images obtained from captured images captured by the second camera. Then, the selection unit 51 selects, from the plurality of object images with which the attention tracking ID is associated, some or all of the plurality of object images based on object identification reliabilities of the plurality of object images. In other words, the selection unit 51 selects, from Q (the value of Q is an integer equal to or larger than K) object images with which the attention tracking ID is associated, K object images based on Q object type reliabilities associated with the Q respective object images. For example, the selection unit 51 may select, from the Q object images, K object images from the one having the highest object type reliability.

The above selection processing may be performed as the number of object images which are accumulated in the selection unit 51 and with which the attention tracking ID is associated has become equal to or larger than a predetermined threshold. Then, the selection unit 51 outputs the K selected object images to the determination unit 52 and the sorting unit 53, whereas the selection unit 51 outputs (Q-K) object images other than the K selected object images to the information output unit 55.

Like the determination unit 11, the determination unit 52 determines, of the N (the value of N is an integer equal to or larger than two) object images with which the attention tracking ID is associated, the value of M (the value of M is an integer equal to or larger than one but equal to or smaller than N), which is the number of object images whose features will be extracted. In particular, the determination unit 52 determines the value of M in accordance with “the usage status of the processing resources of the feature extraction apparatus 10”.

Further, the determination unit 52 determines, of the K (the value of K is an integer equal to or larger than two) object images with which the attention tracking ID is associated, the value of L (the value of L is an integer equal to or larger than one but equal to or smaller than K), which is the number of object images whose features will be extracted. In particular, the determination unit 52 determines the value of L in accordance with “the usage status of the processing resources of the feature extraction apparatus 10”.

The sorting unit 53 selects M object images from the above N object images received from the selection unit 31, like the sorting unit 32. The value of M is a value determined in the determination unit 52. Then, the sorting unit 53 outputs M object images whose “features will be extracted” to the feature extraction unit 54 and outputs, of the N object images, (N−M) object images whose “features will not be extracted” other than the M object images whose features will be extracted to the information output unit 55.

The sorting unit 53 selects L object images from the above K object images received from the selection unit 51. The value of L is a value determined in the determination unit 52. Then, the sorting unit 53 outputs L object images whose “features will be extracted” to the feature extraction unit 54 and outputs, of the K object images, the (K-L) object images whose “features will not be extracted” other than L object images whose features will be extracted to the information output unit 55.

The feature extraction unit 54 receives the object images and extracts features of objects included in the received object images. Then, the feature extraction unit 54 outputs the object images associated with the features extracted from the object images to the information output unit 55.

The information output unit 55 outputs “object information” including information received from the selection unit 31, the selection unit 51, the sorting unit 53, and the feature extraction unit 54. That is, the “object information” includes, for example, the object image ID of each of M object images whose features will be extracted and “extracted information” indicating that the features of each of M object images whose features will be extracted have been extracted, and the object image ID of the (N−M) object images whose features will not be extracted and “unextracted information” indicating that features of each of the (N-M) object images whose features will not be extracted have not been extracted. This “object information” further includes the object image ID of each of the L object images whose features will be extracted and “extracted information” indicating that the features of each of the L object images whose features will be extracted have been extracted and the object image ID of the (K−L) object images whose features will not be extracted and “unextracted information” indicating that features of each of the (K−L) object images whose features will not be extracted have not been extracted.

As described above, according to the third example embodiment, one feature extraction apparatus 50 performs processing on images captured by a first camera and processing on images captured by a second camera different from the first camera, whereby it is possible to efficiently use processing resources of the feature extraction apparatus 50.

### Other Example Embodiments

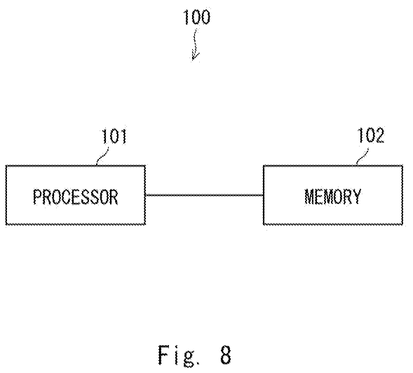

FIG. 8 is a diagram showing a hardware configuration example of a feature extraction apparatus. In FIG. 8, a feature extraction apparatus 100 includes a processor 101 and a memory 102. The processor 101 may be, for example, a microprocessor, a Micro Processing Unit (MPU), or a Central Processing Unit (CPU). The processor 101 may include a plurality of processors. The memory 102 is composed of a combination of a volatile memory and a non-volatile memory. The memory 102 may include a storage located away from the processor 101. In this case, the processor 101 may access the memory 102 via an I/O interface that is not shown.

The feature extraction apparatuses 10, 30, and 50 according to the first to third example embodiments may each include a hardware configuration as shown in FIG. 8. The determination units 11 and 52, the feature extraction units 12 and 54, the selection units 31 and 51, the sorting units 32 and 53, and the information output units 33 and 55 of the feature extraction apparatuses 10, 30, and 50 according to the first to third example embodiments may be achieved by causing the processor 101 to load the program stored in the memory 102 and execute the loaded program. The program(s) can be stored and provided to the feature extraction apparatuses 10, 30, and 50 using any type of non-transitory computer readable media. Examples of the non-transitory computer readable media include magnetic storage media (such as flexible disks, magnetic tapes, hard disk drives, etc.) and optical magnetic storage media (e.g., magneto-optical disks). Further, examples of the non-transitory computer readable media include CD-Read Only Memory (ROM), CD-R, and CD-R/W. Further, examples of the non-transitory computer readable media include semiconductor memories. Examples of the semiconductor memories include, for example, mask ROM, Programmable ROM (PROM), Erasable PROM (EPROM), flash ROM, and Random Access Memory (RAM). Further, the program(s) may be provided to the feature extraction apparatuses 10, 30, and 50 using any type of transitory computer readable media. Examples of the transitory computer readable media include electric signals, optical signals, and electromagnetic waves. The transitory computer readable media can provide the program to the feature extraction apparatuses 10, 30, and 50 via a wired communication line (e.g., electric wires, and optical fibers) or a wireless communication line.

According to the present disclosure, it is possible to provide a feature extraction apparatus, an information processing apparatus, a method, and a program capable of efficiently using processing resources.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims. Each of the example embodiments can be combined with other example embodiments as appropriate.

The whole or part of the example embodiments disclosed above can be described as, but not limited to, the following supplementary notes.

### (Supplementary Note 1)

A feature extraction apparatus comprising:
a feature extraction unit configured to receive an object image and extract at least one feature of an object included in the received object image; and
a determination unit configured to determine a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

### (Supplementary Note 2)

The feature extraction apparatus according to Supplementary Note 1, comprising:
an information output unit configured to output object information including received information; and
a sorting unit configured to receive the N object images and output, of the N object images that have been received, the M object images whose features will be extracted to the feature extraction unit, and output, of the N object images, (N-M) object images whose features will not be extracted other than the M object images whose features will be extracted, to the information output unit.

### (Supplementary Note 3)

The feature extraction apparatus according to Supplementary Note 2, further comprising a selection unit configured to select, from P (the value of P is an integer equal to or larger than N) object images with which the first tracking ID is associated, the N object images based on P priorities associated with the respective P object images and output the N selected object images to the sorting unit, and output (P−N) object images other than the N selected object images to the information output unit.

### (Supplementary Note 4)

The feature extraction apparatus according to Supplementary Note 2, wherein the information output unit outputs the object information including an object image ID of each of the M object images and extracted information indicating that features of each of the M object images whose features will be extracted have been extracted and an object image ID of the (N−M) object images and unextracted information indicating features of each of the (N−M) object images whose features will not be extracted have not been extracted.

### (Supplementary Note 5)

The feature extraction apparatus according to Supplementary Note 2, wherein
the determination unit determines a value of L (the value of L is an integer equal to or larger than one but equal to or smaller than K), which is the number of object images whose features will be extracted of K (the value of K is an integer equal to or larger than two) object images with which a second tracking ID different from the first tracking ID is associated, in accordance with a situation of processing resources of the feature extraction apparatus;
the sorting unit receives the K object images and outputs, of the K received object images, the L object images whose features will be extracted to the feature extraction unit, and outputs, of the K object images, (K-L) object images whose features will not be extracted other than the L object images whose features will be extracted to the information output unit,
the N object images with which the first tracking ID is associated are object images detected in N first image frames captured by a first camera, and
the K object images with which the second tracking ID is associated are object images detected in K second image frames captured by a second camera different from the first camera.

### (Supplementary Note 6)

The feature extraction apparatus according to Supplementary Note 5, wherein
a first selection unit configured to select, from P (the value of P is an integer equal to or larger than N) object images with which the first tracking ID is associated, the N object images based on P priorities associated with the respective P object images and output the N selected object images to the sorting unit, and output (P−N) object images other than the N selected object images to the information output unit, and
a second selection unit configured to select, from Q (the value of Q is an integer equal to or larger than K) object images with which the second tracking ID is associated, the K object images based on Q priorities associated with the Q respective object images and output the K selected object images to the sorting unit, and output (Q−K) object images other than the K selected object images to the information output unit.

### (Supplementary Note 7)

An information processing apparatus comprising:
the feature extraction apparatus according to Supplementary Note 1;
a detection unit configured to detect, in each of a plurality of captured images, an object region that corresponds to an object, identify positions of the respective object regions in the captured images, attach object IDs to the respective object regions, and output a plurality of object images, each of the object images including a captured image where the object region is detected, image identification information indicating the captured image, information regarding the identified position, and the object ID; and
a tracking unit configured to attach one tracking ID to all object images of one object using the plurality of object images received from the detection unit and output, to the feature extraction apparatus, the plurality of object images to which the tracking ID is attached.

### (Supplementary Note 8)

An information processing apparatus comprising:
the feature extraction apparatus according to Supplementary Note 5;
a first detection unit configured to detect, in each of a plurality of first image frames captured by the first camera, an object region that corresponds to an object, identify positions of the respective object regions in the first image frames, attach object IDs to the respective object regions, and output a plurality of first object images, each of the first object images including a first image frame where the object region is detected, image identification information indicating the first image frame, information regarding the identified position, and the object ID;
a first tracking unit configured to attach one tracking ID to all first object images of one object using the plurality of first object images received from the first detection unit, and output, to the feature extraction apparatus, the plurality of first object images to which the tracking ID is attached;
a second detection unit configured to detect, in each of a plurality of second image frames captured by the second camera, an object region that corresponds to an object, identify positions of the respective object regions in the second image frames, attach object IDs to the respective object regions, and output a plurality of second object images, each of the second object images including a second image frame where the object region is detected, image identification information indicating the second image frame, information regarding the identified position, and the object ID; and a second tracking unit configured to attach one tracking ID to all second object images of one object using the plurality of second object images received from the second detection unit, and output the plurality of second object images to which the tracking ID is attached to the feature extraction apparatus.

### (Supplementary Note 9)

A method executed by a feature extraction apparatus, the method comprising:
extracting at least one feature of an object included in an object image; and
determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

### (Supplementary Note 10)

The method according to Supplementary Note 9, further comprising sorting the M object images of the N object images as targets whose features will be extracted and sorting, of the N object images, (N−M) object images other than the M object images whose features will be extracted as targets whose features will not be extracted.

### (Supplementary Note 11)

A program for causing a feature extraction apparatus to execute processing comprising:
extracting at least one feature of an object included in an object image; and
determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

### (Supplementary Note 12)

The program according to Supplementary Note 11, wherein the processing further comprises sorting the M object images of the N object images as targets whose features will be extracted and sorting, of the N object images, (N−M) object images other than the M object images whose features will be extracted as targets whose features will not be extracted.

What is claimed is:

1. A feature extraction apparatus comprising:
at least one memory configured to store instructions; and
at least one processor configured to execute, according to the instructions, a process comprising:
receiving an object image and extracting at least one feature of an object included in the received object image; and
determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

2. The feature extraction apparatus according to claim 1, wherein the process further comprises:
outputting object information including received information; and
receiving the N object images and outputting, of the N object images that have been received, the M object images whose features will be extracted to the process of the extracting, and outputting, of the N object images, (N−M) object images whose features will not be extracted other than the M object images whose features will be extracted, to the process of the outputting of object information.

3. The feature extraction apparatus according to claim 2, wherein the process further comprises selecting, from P (the value of P is an integer equal to or larger than N) object images with which the first tracking ID is associated, the N object images based on P priorities associated with the respective P object images and outputting the N selected object images to the process of the sorting, and outputting (P−N) object images other than the N selected object images to the process of the outputting of object information.

4. The feature extraction apparatus according to claim 2, wherein the outputting of object information includes outputting the object information including an object image ID of each of the M object images and extracted information indicating that features of each of the M object images whose features will be extracted have been extracted and an object image ID of the (N−M) object images and unextracted information indicating features of each of the (N−M) object images whose features will not be extracted have not been extracted.

5. The feature extraction apparatus according to claim 2, wherein
the determining includes determining a value of L (the value of L is an integer equal to or larger than one but equal to or smaller than K), which is the number of object images whose features will be extracted of K (the value of K is an integer equal to or larger than two) object images with which a second tracking ID different from the first tracking ID is associated, in accordance with a situation of processing resources of the feature extraction apparatus;
the sorting includes receiving the K object images and outputting, of the K received object images, the L object images whose features will be extracted to the process of the extracting, and outputting, of the K object images, (K−L) object images whose features will not be extracted other than the L object images whose features will be extracted to the process of the outputting of object information,
the N object images with which the first tracking ID is associated are object images detected in N first image frames captured by a first camera, and
the K object images with which the second tracking ID is associated are object images detected in K second image frames captured by a second camera different from the first camera.

6. The feature extraction apparatus according to claim 5, wherein the process includes:
selecting, from P (the value of P is an integer equal to or larger than N) object images with which the first tracking ID is associated, the N object images based on P priorities associated with the respective P object images and outputting the N selected object images to the process of the sorting, and outputting (P−N) object images other than the N selected object images to the process of the outputting of object information, and
selecting, from Q (the value of Q is an integer equal to or larger than K) object images with which the second tracking ID is associated, the K object images based on Q priorities associated with the Q respective object images and outputting the K selected object images to the process of the sorting, and outputting (Q−K) object images other than the K selected object images to the process of the outputting of object information.

7. An information processing apparatus comprising, the feature extraction apparatus according to claim 1, wherein
the process further comprises:
detecting, in each of a plurality of captured images, an object region that corresponds to an object, identifying positions of the respective object regions in the captured images, attaching object IDs to the respective object regions, and outputting a plurality of object images, each of the object images including a captured image where the object region is detected, image identification information indicating the captured image, information regarding the identified position, and the object ID; and
attaching one tracking ID to all object images of one object using the plurality of object images received from the process of the detecting and outputting, to the process of the extracting, the plurality of object images to which the tracking ID is attached.

8. An information processing apparatus comprising, the feature extraction apparatus according to claim 5,
the process further comprises:
detecting, in each of a plurality of first image frames captured by the first camera, an object region that corresponds to an object, identifying positions of the respective object regions in the first image frames, attaching object IDs to the respective object regions, and outputting a plurality of first object images, each of the first object images including a first image frame where the object region is detected, image identification information indicating the first image frame, information regarding the identified position, and the object ID;
attaching one tracking ID to all first object images of one object using the plurality of first object images received from the process of the detecting, and outputting, to the feature extraction apparatus, the plurality of first object images to which the tracking ID is attached;
detecting, in each of a plurality of second image frames captured by the second camera, an object region that corresponds to an object, identifying positions of the respective object regions in the second image frames, attaching object IDs to the respective object regions, and outputting a plurality of second object images, each of the second object images including a second image frame where the object region is detected, image identification information indicating the second image frame, information regarding the identified position, and the object ID; and
attaching one tracking ID to all second object images of one object using the plurality of second object images received from the process of the detecting, and outputting the plurality of second object images to which the tracking ID is attached to the process of the extracting.

9. A method executed by a feature extraction apparatus, the method comprising:
extracting at least one feature of an object included in an object image; and
determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.

10. A non-transitory computer readable medium storing a program for causing a feature extraction apparatus to execute processing comprising:
extracting at least one feature of an object included in an object image; and
determining a value of M (the value of M is an integer equal to or larger than one but equal to or smaller than N), which is the number of object images whose features will be extracted of N (the value of N is an integer equal to or larger than two) object images with which a first tracking ID, which is an identifier allocated to one object, is associated, in accordance with a usage status of processing resources of the feature extraction apparatus.
